(19) United States
(12) Patent Application Publication
(10) Pub. No.: US 2018/0260890 A1
(43) Pub. Date: Sep. 13, 2018

(54) TAX DEFERRAL REPORT SYSTEM

(71) Applicants: STEVEN A. SASS, Auburndale, MA (US); Robert M. Finkel, New York, NY (US); Francis Vitagliano, Boston, MA (US)

(72) Inventors: STEVEN A. SASS, Auburndale, MA (US); Robert M. Finkel, New York, NY (US); Francis Vitagliano, Boston, MA (US)

(21) Appl. No.: 15/913,302

(22) Filed: Mar. 6, 2018

Related U.S. Application Data
(60) Provisional application No. 62/468,079, filed on Mar. 7, 2017.

(51) Int. Cl. G06Q 40/02; G06Q 40/00

(52) U.S. Cl. CPC G06Q 40/025; G06Q 40/12; G06Q 40/10

(57) ABSTRACT

Technologies are described for devices and methods to generate a report. The methods may comprise, by a report processor, receiving credit data and interest data and property tax data. The methods may comprise determining an owner of a property meets eligibility criteria, notifying the owner, and receiving an election. The methods may comprise receiving lien data. The lien data may be related to a dated municipal tax lien on the property. The methods sending the lien data to a tax anticipation security processor. The tax anticipation security processor may generate tax anticipation security data related to a tax anticipation security. The tax anticipation security may be secured by the dated municipal tax lien. The methods may comprise receiving the tax anticipation security data and generating the report. The report may include data related to the owner, the property, the tax lien data, and the tax anticipation security data.

### BACKGROUND

Unless otherwise indicated herein, the materials described in this section are not prior art to the claims in this application and are not admitted to be prior art by inclusion in this section. Property tax deferrals may be offered by some governments to homeowners either on an eligibility basis or by application without eligibility criteria. In either case, a homeowner may be required to apply for a government tax deferral. When eligibility criteria is required, the eligibility criteria and vetting may be repeated each year. When property taxes are deferred, an interest rate may be charged on the amount of property taxes deferred.

In conventional tax deferral programs, when a homeowner elects to defer property taxes, the government entity may place a municipal lien on the home in an amount equal to the tax. The municipal lien may cover accruing interest at a determined rate and any subsequent property tax deferrals. In some instances a state agency may pay the property tax, extinguish the municipal lien, and place a state lien on the home. In these instances, the state lien may be less senior than any subsequent municipal tax lien.

In conventional methods and systems of tax deferrals, the government entity, including a state agency that pays the property tax, may receive the deferred tax amount only upon the sale of the home; either a voluntary sale or a foreclosure sale if the home is abandoned or not sold when the homeowner dies in violation of the property tax deferral agreement. Until the government entity receives the payment, the liens may remain on the books of the government entity. The claim may be satisfied when the government entity receives cash upon the sale of the home.

### SUMMARY

One embodiment of the invention is systems to generate a report. The systems may comprise a report processor in communication with a first memory. The systems may comprise a property tax processor in communication with a property tax database. The systems may comprise an underwriter risk assessment generator. The systems may comprise a tax lien processor. The systems may comprise a tax anticipation security processor. The report processor may be in communication with the property tax processor, the underwriter risk assessment generator, the tax lien processor, and the tax anticipation security processor over a network. The underwriter risk assessment generator may be configured to generate credit data related to credit availability. The underwriter risk assessment generator may be configured to generate interest data related to an interest rate. The underwriter risk assessment generator may be configured to send the credit data related to credit availability and the interest data related to the interest rate to the report processor. The report processor may be configured to receive the credit data related to credit availability and the interest data related to the interest rate from the underwriter risk assessment generator. The report processor may be configured to store the credit data and the interest data in the first memory. The report processor may be configured to determine eligibility criteria for a program based on the credit data and the interest data. The report processor may be configured to store the eligibility criteria in the first memory. The property tax processor may be configured to generate property tax data based on data in a property tax database. The property tax data may include data related to properties within an area governed by a government entity, owners of properties within the area governed by the government entity, and taxes due on the properties within the area governed by the government entity for a year. The property tax processor may be configured to send the property tax data to the report processor. The report processor may be further configured to receive the property tax data and store the property tax data in the first memory. The report processor may be configured to determine that a particular owner of a particular property meets the eligibility criteria based on the eligibility criteria and the property tax data. The report processor may be configured to store an identifier of the particular owner and the particular property in the first memory. The property tax processor may be configured to generate a notification command. The notification command may be effective to initiate a generation of an eligibility notification for the particular owner of the particular property. The report processor may be configured to receive a signal from the particular owner of the particular property. The signal may include a notification election. The report processor may be configured to store the notification election in the first memory. The report processor may be configured to send the notification election to the tax lien processor. The tax lien processor may be configured to receive the notification election. The tax lien processor may be configured to generate lien data related to a dated municipal tax lien on the property. The dated municipal tax lien may be an amount equal to property tax on the particular property for a pending year and associated fees, and the dated municipal tax lien may be structured with interest accruing at specified rates. The tax lien processor may be configured to send the lien data to the report processor. The report processor may be further configured to receive the lien data and store the lien data in the first memory. The report processor may be configured to send the lien data to the tax anticipation security processor. The tax anticipation security processor may be configured to receive the lien data. The tax anticipation security processor may be configured to generate tax anticipation security data related to a tax anticipation security based on the lien data. The tax anticipation security data may relate to a tax anticipation security which is secured by the dated municipal tax lien in an amount equal to the property tax on the particular property for the pending year, the associated fees, and the interest accrued at the specified rates. The tax anticipation security processor may be configured to send the tax anticipation security data to the report processor. The report processor may be further configured to receive the tax anticipation security data and store the tax anticipation security data in the first memory. The report processor may be configured to generate the report. The report may include data related to the particular owner, the particular property, the tax lien data, and the tax anticipation security data.

Another embodiment of the invention includes methods to generate a report. The methods may comprise a report processor receiving credit data related to credit availability and interest data related to an interest rate from an underwriter risk assessment generator. The methods may comprise the report processor storing the credit data and the interest data in a first memory. The methods may comprise the report processor determining eligibility criteria for a program based on the credit data and the interest data. The methods may comprise the report processor storing the eligibility criteria in the first memory. The methods may comprise the report processor receiving property tax data from a property tax processor. The methods may comprise the report processor storing the property tax data in the first memory. The methods may comprise the report processor determining a particular owner of a particular property meets the eligibility criteria based on the eligibility criteria and the property tax data. The methods may comprise the report processor storing an identifier of the particular owner and the particular property in the first memory. The methods may comprise the report processor generating a notification command. The notification command may be effective to initiate the generation of a notification for the particular owner of the particular property. The methods may comprise the report processor receiving a signal from the owner of the particular property. The signal may include a notification election. The methods may comprise the report processor storing the notification election in the first memory. The methods may comprise the report processor sending the notification election to a tax lien processor. The tax lien processor may generate lien data related to a dated municipal tax lien on the property. The dated municipal tax lien may be an amount equal to property tax on the property for a pending year and associated fees. The dated municipal tax lien may be structured with interest accruing at specified rates. The methods may comprise the report processor receiving the tax lien data from the tax lien processor. The methods may comprise the report processor storing the tax lien data in the first memory. The methods may comprise the report processor sending the lien data to a tax anticipation security processor. The tax anticipation security processor may generate tax anticipation security data related to a tax anticipation security based on the lien data. The tax anticipation security may be secured by the dated municipal tax lien in an amount equal to the property tax on the property for the pending year, the associated fees, and the interest accrued at the specified rates. The methods may comprise the report processor receiving the tax anticipation security data. The methods may comprise the report processor storing the tax anticipation security data in the first memory. The methods may comprise the report processor generating the report. The report may include data related to the particular owner, the particular property, the tax lien data, and the tax anticipation security data.

Another embodiment of the invention is devices effective to generate a report. The devices may comprise a report processor in communication with a first memory. The memory may include instructions. The report processor may be configured to execute the instructions to receive credit data related to credit availability and interest data related to an interest rate from an underwriter risk assessment generator. The report processor may be configured to execute the instructions to store the interest data in a first memory. The report processor may be configured to execute the instructions to determine eligibility criteria for a program based on the credit data and the interest data. The report processor may be configured to execute the instructions to store the eligibility criteria in the first memory. The report processor may be configured to execute the instructions to receive property tax data from a property tax processor. The report processor may be configured to execute the instructions to store the property tax data in the first memory. The report processor may be configured to execute the instructions to determine a particular owner of a particular property meets the eligibility criteria based on the eligibility criteria and the property tax data. The report processor may be configured to execute the instructions to store an identifier of the particular owner and the particular property in the first memory. The report processor may be configured to execute the instructions to generate a notification command. The notification command may be effective to initiate the generation of a notification for the particular owner of the particular property. The report processor may be configured to execute the instructions to receive a signal from the particular owner of the particular property. The signal may include a notification election. The report processor may be configured to execute the instructions to store the notification election in the first memory. The report processor may be configured to execute the instructions to send the notification election to a tax lien processor. The tax lien processor may generate lien data related to a dated municipal tax lien on the particular property. The dated municipal tax lien may be an amount equal to property tax on the particular property for a pending year and associated fees. The dated municipal tax lien may be structured with interest accruing at specified rates. The report processor may be configured to execute the instructions to receive the tax lien data from the tax lien processor. The report processor may be configured to execute the instructions to store the tax lien data in the first memory. The report processor may be configured to execute the instructions to send the lien data to a tax anticipation security processor. The tax anticipation security processor may generate tax anticipation security (TAS) data related to a tax anticipation security based on the lien data. The tax anticipation security may be secured by the dated municipal tax lien in an amount equal to the property tax on the particular property for the pending year, the associated fees, and the interest accrued at the specified rates. The report processor may be configured to execute the instructions to receive the tax anticipation security data. The report processor may be configured to execute the instructions to store the tax anticipation security data in the first memory. The report processor may be configured to execute the instructions to generate the report. The report may include data related to the owner, the property, the tax lien data, and the tax anticipation security data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a tax deferral report system; and

FIG. 2 depicts a flow diagram for an example process for implementing a tax deferral report system; and

all arranged in accordance with at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to technologies including methods, apparatus, systems, devices, and computer program products related to implementing a tax deferral system.

Briefly stated, a government processor may generate a report for a tax deferral for a property. The government processor may determine that a property and an owner qualify for a tax deferral based on property tax data, interest rate data, and eligibility criteria. The government processor may notify the owner of the property. The owner may elect to participate in the tax deferral. The government processor may receive data related to a dated municipal tax lien for the property and data related to a tax anticipation security for the property. The government processor may generate a tax deferral report based on the owner, the property, the data related to the dated municipal tax lien, and the data related to a tax anticipation security.

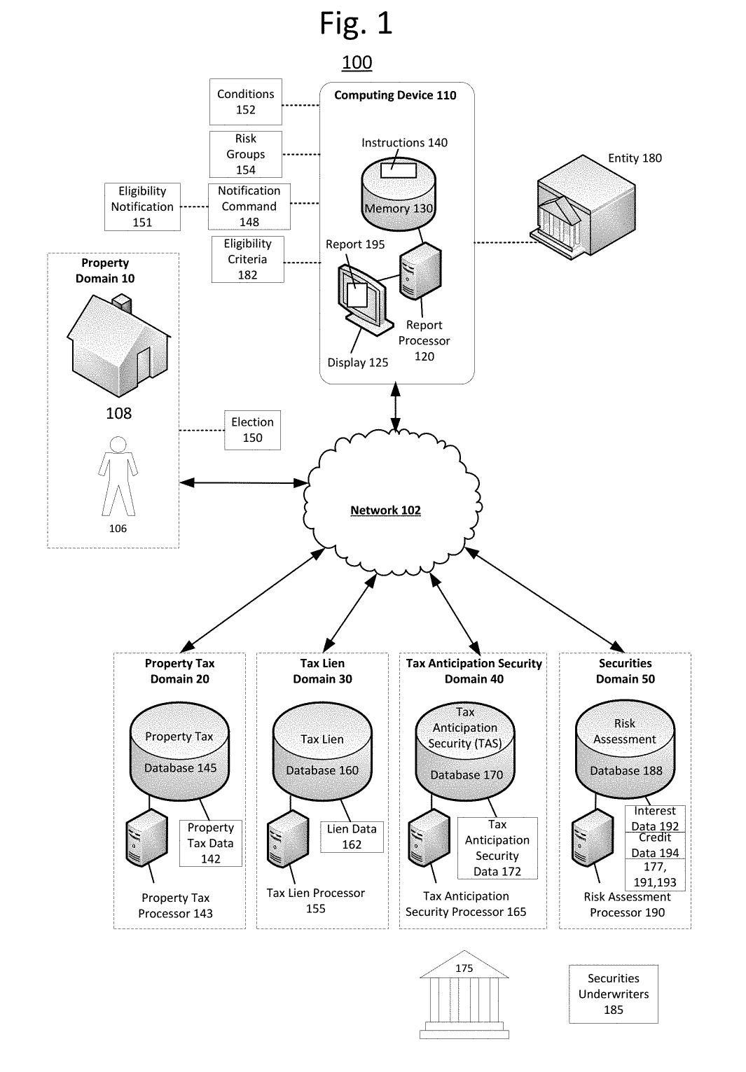

FIG. 1 illustrates an example system that can be utilized to implement a tax deferral system, arranged in accordance with at least some embodiments presented herein. System 100 may include a computing device 110, a network 102, a property domain 10, a property tax domain 20, a tax lien domain 30, a tax anticipation security domain 40, and a securities domain 50. Property domain 10 may include a property 108 and an owner 106 of property 108. Computing device 110 may include a report processor 120 in communication with a display 125 and a memory 130. Memory 130 may include instructions 140. Property tax domain 20 may include a property tax processor 143 in communication with a property tax database 145. Tax lien domain 30 may include a tax lien processor 155 in communication with a tax lien database 160. Tax anticipation security domain 40 may include a tax anticipation security processor 165 in communication with a tax anticipation security database 170. Securities domain 50 may include risk assessment processor 190 in communication with a risk assessment database 188. Computing device 110 may be in communication with property tax processor 143, tax lien processor 155, tax anticipation security processor 165, and risk assessment generator 190 through network 102. Network 102 may include, for example, the Internet, a Local Area Network (“LAN”), or a wide area network.

Computing device 110 may be a computing device of a government entity 180. Government entity 180 may collect property tax on properties located within an area governed by government entity 108. Properties within property domain 10 may be located in an area governed by government entity 180. Property taxes on properties located in an area governed by government entity 180 may be determined by property tax domain 20. Owners of properties within an area governed by government entity 180 and taxes due on properties within an area governed by government entity 180 for a year may be compiled by property tax processor 143 and stored in property tax database 145 as property tax data 142. Property tax processor 143 may send property tax data 142 to report processor 120.

Report processor 120 may receive property tax data 142 from property tax processor 143. Report processor 120 may store property tax data 142 in memory 130. Report processor 120 may determine eligibility criteria 182 for a property tax deferral program for properties identified in property tax data 142. Report processor 120 may send property tax data 142 to risk generator 190. Risk assessment generator 190 may be a risk assessment generator in securities domain 50. Securities domain 50 may include underwriters 185. Risk assessment generator 190 may determine groups 177 based on an expected duration of a deferral. Groups 177 may be duration-risk groups. Groups 177 may be determined by risk assessment generator 190 based at least in part on risk characteristics that may affect the likelihood that there will be adequate equity in a property to cover a tax deferral plus program costs and accrued interest at an estimated time that the deferral period will end. For example, groups 177 may be determined by risk assessment generator 190 based on an age of a youngest owner 106 of property 108. Risk assessment generator 190 may determine owners 106 ages 65-74 to be in a first group 177, owners 106 ages 75-84 to be in a second group 177, and owners ages 85 and older to be in a third group 177. Groups 177 may be stored in risk assessment database 188. Risk assessment generator 190 may estimate an expected duration 191 of a deferral based, at least in part, on an age of the youngest owner of a property, a marital status of an owner of a property, and a location of a property. Risk assessment generator 190 may determine risk characteristics 193. Risk characteristics 193 may be stored in risk assessment database 188. Risk characteristics 193 may include, but are not limited to, the ratio of equity to the assessed value of a property, potential changes in local (municipality) property values, the availability of credit and the interest rate charged for funding deferrals in each duration-risk group, an ability to group tax anticipation securities of similar expected duration and risk characteristics, the presence of other property tax deferral liens and the interest rate on any such deferrals, and the ratio of prospective property tax deferral liens to the assessed value of a property. Risk assessment generator 190 may generate credit data 194 and interest data 192 for groups 177, based on each group 177 estimated duration 191 and risk characteristics 193. Credit data 194 may be related to market-based assessments of credit availability. Interest data 192 may include an interest rate and data related to groups 177, estimated duration 191, and risk characteristics 193. In an example, an interest rate may be determined by risk assessment generator 190 to be a 1-year Constant Maturity Treasury interest rate at a specified date plus a margin that varies with the expected duration of the deferral and risk of repayment. Risk assessment generator 190 may send credit data 194 and interest data 192 to report processor 120. Risk assessment generator 190 may send credit data 194 and interest data 192 to report processor 120 annually, semi-annually, or on a specific date determined by government entity 180.

Report processor 120 may receive interest data 192 from risk assessment generator 190 over network 102. Report processor 120 may store interest data 192 in memory 130. Report processor 120, prior to the issuance of annual property tax notices by government entity 180, may sort owners 106 and properties 108 in property tax data 142 into groups 177. Processor may determine conditions 152 associated with each group 177 based on risk characteristics 193 data in interest data 192. Report processor 120 may sort properties 108 into risk groups 154 within each group 177 according to a ratio of prospective property deferral liens to the assessed value of property 108.

Report processor 120 may determine eligibility based on eligibility criteria 182 credit availability in credit data 194 and an interest rate in interest data 192. Report processor 120 may further determine eligibility criteria 182 based on conditions 152. Report processor 120 may store eligibility criteria 182 in memory 130. Eligibility criteria 182 may include a qualifying age of the youngest person that is an owner 106 of property 108, a type of property 108, whether owner 106 must occupy property 108, a maximum or minimum value of property 108, and whether there is a mortgage or other lien on property 108 other than property tax deferral liens. In an example, owner 106 may be determined to be eligible if owner 106 is age 65 or older and the youngest owner of property 108. In another example, owner 106 may be determined to be eligible if owner 106 owns and occupies property 108 and property 108 is a single family, condominium, or 2-3 family home. Eligibility of owner 106 may also be based on a market-based assessment of whether owner 106 has adequate equity in property 108 to cover the tax deferrals, any program costs, and all anticipated accrued interest at a market-based rate at the estimated time that the deferral period will end. Eligibility of owner 106 may be determined based on the availability of credit as determined by the market-based risk assessment in credit data 194. Owner 106 may be eligible for a property tax deferral if owner 106 has limited incomes or financial assets. Report processor 120 may determine properties and owners within an area governed by government entity 180 that meet or might meet eligibility criteria 182. Report processor 120 may search property tax data 142 based on eligibility criteria 182 to determine owners and properties which meet eligibility criteria 182. For example, report processor 120 of government entity 180 may determine a property 108 and an owner 106 of property 108 meet criteria 182 and are eligible for a property tax deferral program. Report processor 120 may store an identifier of owner 106 and property 108 in memory 130.

Report processor 120 may determine and specify how subsidies, guarantees, or other initiatives could expand eligibility and/or make deferrals available on more advantageous terms to specific groups 177 of owners. For example, a subsidy may be determined that reduces taxes on property 108 or reduces program fees, so that the ratio of prospective property tax deferral liens on property 108, financed by the one or more tax anticipation securities, may be below a specified percentage of the assessed value of property 108. In another example, a guarantee may use a “full faith and credit” of government entity 180 to assure lenders that the amount financed, or a portion of the amount financed, will be repaid; an initiative that may allow owners 106 to refinance a mortgage with a loan that allows the presence of senior property tax deferral liens. Report processor 120 of government entity 180 may determine whether to offer subsidies, guarantees, or other initiatives to expand eligibility and/or make deferrals available on more advantageous terms to specific groups 177 of owners.

Government entity 180 may notify owner 106 of property 108 of an eligibility status. Report processor 120, upon determining owner 106 and property 108 meet criteria 182, may generate a notification command 148. Notification command 148 may be effective to initiate the generation of an eligibility notification 151 for owner 106 and property 108. Eligibility notification 151 for owner 106 may be sent to owner 106 upon generation of eligibility notification 151. In an example, eligibility notification 151 may be sent to owner 106 in conjunction with a notification of taxes due on property 108. In another example, notification command 148 may be effective to initiate a notification letter to be generated for owner 106. Upon generation of a notification letter for owner 106, the notification letter may be mailed to owner 106. In another example, notification command 148 may be effective to initiate generation of a notification phone call or text to be sent to owner 106. In a further example, notification command 148 may be effective to initiate a generation of a notification email to be sent to owner 106.

An eligibility notification 151 send by government entity 180 may notify eligible owners 106 of their ability to defer payment of property taxes for a pending year and conditions 152 for such a deferral. Owners 106 may be informed of their potential ability to defer paying property taxes for a pending year, and conditions 152 for such a deferral. Conditions 152 for a property tax deferral may include: up-front fees and an interest rate charged for the duration of the deferral; the deferred amount may not need to be repaid as long as owners 106 live in the property 108; the deferred amount may be secured by a lien on property 108, and may only be secured by a lien on property 108 which is junior to any prior liens on property 108 and senior to any subsequent liens on property 108; the deferred amount may be repaid, in whole or in part, at any time, if all senior liens have been repaid; and owner 106 may be required to notify government entity 180 that owner 106 elects to defer by a specified date. Owners 106 may be notified through any combination of communication media together or independently of notification of a property tax obligation for property 108. For example, owner 106 may be sent an eligibility notification 151 via letter mail service, electronic mail, applications, telephone calls, etc. An eligibility notification 151 may include an assessed value of property 108, any existing liens on property 108, an amount of equity of owner 106 in property 108, and other information which may be useful to owner 106.

Owner 106 of property 108 within an area governed by government entity 180 may receive a notification from government entity 180 stating owner 106 and property 108 are eligible for a property tax deferral for a tax year. Owner 106 may send an election to government entity 180 requesting to defer property tax payments on property 108 for a tax year. Report processor 120 may receive election 150 indicating intent of owner 106 to participate in a tax deferral. Report processor 120 may save an indication of election 150 in memory 130.

Report processor 120 may send election 150 and interest data 192 to tax lien processor 155 of tax lien domain 30. In response, tax lien processor 155 may generate lien data 162 for property 108. Lien data 162 may be stored in lien database 160. Lien data 162 may include data related to a dated municipal tax lien on property 108. Lien data 162 may include data related to a dated municipal tax lien on property 108 in an amount equal to property tax on property 108 for a pending year plus associated fees which may be related to interest data 192. Lien data 162 may include data related to a dated municipal tax lien on property 108 which is structured with interest accruing at specified rates based on interest data 192. Lien data 162 may include data related to a dated municipal tax lien on property 108 where the dated municipal tax lien is not enforced by government entity 180. Tax lien processor 155 may send lien data 162 to report processor 120.

Report processor 120 may receive lien data 162. Report processor 120 may store lien data 162 in memory 130. Report processor 120 may send lien data 162 and interest data 192 to tax anticipation security processor 165 of tax anticipation security domain 40 over network 102. Tax anticipation security processor 165 may be a processor of issuing entity 175 which may issue tax anticipation securities. Issuing entity 175 may be a division of government entity 180. Government entity 180 may provide issuing entity 175 information on each deferral including, but not limited to, the amount of property tax and up-front program fees deferred and the interest rate charged; the age of the youngest homeowner and the address, assessed value, and existing liens on the home; and that a dated lien securing the obligation has been placed on the home, with interest accruing from the date that taxes are due.

Tax anticipation security processor 165 may generate tax anticipation security data 172 related to a tax anticipation security based on lien data 162 and interest data 192. Tax anticipation security processor 165 may generate tax anticipation security data 172 based on a tax anticipation security that is secured by a dated municipal tax lien in an amount equal to the property tax on property 108 for a pending year, associated fees, and an interest accrued at the specified rates based on interest data 192. Tax anticipation security data 172 may reflect a tax anticipation security generated by tax anticipation security processor 165 for which government entity 180 may repay at least one tax anticipation security holder upon the occurrence of a trigger event. A trigger event may include a payment by owner 106 of property 108 (a payment towards a lien or property tax), property 108 being sold, or a foreclosure of property 108 in the event property 108 is abandoned, delinquent in property tax payment, and/or the death of owner 106. Government entity 180 may repay the at least one tax anticipation security holder a limited amount equal to monies received minus specified costs after the satisfaction of all senior liens associated with property 108. Tax anticipation security processor 165 may send tax anticipation security data 172 to report processor 120 over network 102.

Report processor 120 may receive tax anticipation security data 172. Report processor 120 may store tax anticipation security data 172 in memory 130. Report processor 120 may execute instructions 140 in memory 130 to generate a report 195 based upon property tax data 142, eligibility criteria 182, interest data 192, lien data 162, and tax anticipation security data 172. Report processor 120 may execute instructions 140 to cause report 195 to be displayed on display 125.

Issuing entity 175 may issue one or more groups of one or more tax anticipation securities, one for each group 177; each group may be secured by dated municipal liens associated with property tax deferrals of similar duration and risk. The one or more tax anticipation securities may be issued in an amount and price sufficient to cover the tax obligations and up-front program fees. The one or more tax anticipation securities may be secured by dated property tax deferral liens, not the “full faith and credit” of government entity 180 to which taxes are due or the “full faith and credit” of another government entity (e.g., a state). Upon receipt of the funds from the securities issued, issuing entity 175 may transfers funds to government entity 180 to which taxes are due, if different (i.e., if government entity 180 to which taxes are due is not the issuing entity) an amount equal to property taxes due plus its program costs without delay (that is, without government entity 180 needing to wait until the home is sold and the lien executed).

Government entity 180 may treat taxes that are due for property 108 as unpaid on the books of government entity 180 and dated municipal tax liens against property 108 may remain in force in an amount equal to an initial tax obligation of owner 106, administrative fees, and accruing interest at the specified rate. Government entity 180 may treat the funds received from issuing entity 175 as a deposit, an asset offset by an obligation to pay tax anticipation security holders, or to their designated trustees or agents, the lesser of the lien amount or the proceeds, if any, received when property owner 106 reduce or satisfy tax obligations on property 108 or when property 108 is sold. Proceeds received by government entity 180 to satisfy the lien when property 108 is sold may be reduced by specified costs of the deferral program. Specified costs of the deferral program may include specified recovery costs and incentives paid to government entity 180 to satisfy all claims.

Government entity 180 may ensure the collection of proceeds that satisfy or reduce an amount to be repaid to tax anticipation security holders when property 108 is sold. Government entity 180 may ensure that property 108 is sold in a foreclosure sale if property 108 is abandoned or not sold when owner 106 dies or is in any other violation of the property tax deferral agreement. Government entity 180 may release or reduce the lien securing a tax anticipation security after receiving proceeds from a sale of property 108. A claim on owner 106 from government entity 180 (e.g., through the dated municipal liens) may be transferred to one or more investors holding the one or more tax anticipation security. Government entity 180 may retain an obligation to satisfy the claim and to transfer the proceeds available to tax anticipation security holders or to the tax anticipation security holders' designated trustees or agents. Government entity 180 may have no obligation to make payments greater than the proceeds received for payment of deferred taxes and program fees and accrued interest.

Government entity 180 may receive a deferred tax payment while owner 106 resides in property 108 or upon the sale of property 108. Government entity 180 may allocate funds received to an account of the one or more tax anticipation securities, in order of the seniority of the liens backing a tax anticipation security. Government entity 180 may transfer funds to holders of a tax anticipation security or to their designated trustees or agents, which in turn may disperse funds to tax anticipation security holders or to other designated trustees or agents.

Issuing entity 175 may issue annual reports on a financial status of a tax anticipation security. Issuing entity 175 may issue financial reports for each group of tax anticipation securities. Financial reports may include a value of the outstanding obligation, an assessed value of property 108, a ratio of senior liens against an assessed value of property 108, a designation of a type of property of property 108, a location of property 108, a relationship between assessed values and sales prices of all properties with property tax deferral liens that may have been sold over the previous year, and a location of properties with property tax deferral liens that may have been sold over the previous year. Annual reports provided by issuing entity 175 may increase the transparency of a credit quality of property tax deferrals to financial markets.

Government entity 180 may pay tax anticipation security holders, or the trustees or agents of tax anticipation security holders monies received in payment of the deferred property taxes plus up-front fees and accrued interest, either while owner 106 resides in property 108 or when property 108 is sold. Government entity 180 may foreclose upon property 108 if property 108 is abandoned, delinquent in property tax payments, owners 106 pass away, or other conditions stipulated in a tax anticipation security indenture. Repayment of a tax anticipation security may be secured by a lien on the equity in property 108. Terms of a tax anticipation security indenture may include administrative fees of the program as specified costs and become senior claims on the equity in property 108. Tax anticipation security trustees or agents may be obligated to distribute funds received to tax anticipation security holders, or to some other trustee or agent of tax anticipation security holders, at the time of a periodic distribution (e.g., monthly). Property tax deferrals may be financed by one or more tax anticipation securities issued by issuing entity 175, but may not be secured by the “full faith and credit” of government entity 180 or some other government entity (e.g., a state).

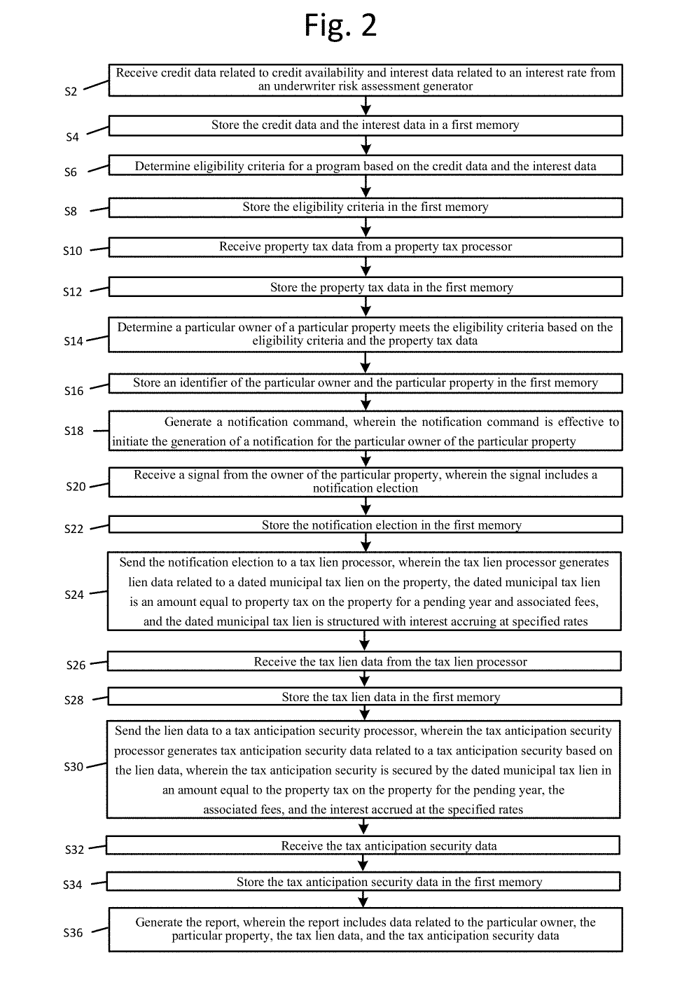

FIG. 2 illustrates a flow diagram for an example process to implement a tax deferral report system, arranged in accordance with at least some embodiments presented herein. The process in FIG. 2 could be implemented using, for example, system 100 discussed above. An example process may include one or more operations, actions, or functions as illustrated by one or more of blocks S2, S4, S6, S8, S10, S12, S14, and/or S16. Although illustrated as discrete blocks, various blocks may be divided into additional blocks, combined into fewer blocks, or eliminated, depending on the desired implementation.

Processing may begin at block S2, “Receive credit data related to credit availability and interest data related to an interest rate from an underwriter risk assessment generator”. At block S2, a report processor may receive credit data and interest data from an underwriter risk assessment generator. The credit data may be related to credit availability. The interest data may be related to an interest rate.

Processing may continue from block S2 to block S4, “Store the credit data and the interest data in a first memory”. At block S4, the report processor may store the credit data and the interest data in a first memory.

Processing may continue from block S4 to block S6, “Determine eligibility criteria for a program based on the credit data and the interest data”. At block S6, the report processor may determine eligibility criteria for a property tax deferral program based on the credit data and the interest data.

Processing may continue from block S6 to block S8, “Store the eligibility criteria in the first memory”. At block S8, the report processor may store the eligibility criteria in the first memory.

Processing may continue from block S8 to block S10, “Receive property tax data from a property tax processor”. At block S10, the report processor may receive property tax data from a property tax processor. The property tax data may include data related to properties and owners in an area

Processing may continue from block S10 to block S12, “Store the property tax data in the first memory”. At block S12, the report processor may store the property tax data in the first memory.

Processing may continue from block S12 to block S14, “Determine a particular owner of a particular property meets the eligibility criteria based on the eligibility criteria and the property tax data”. At block S14, the report processor may determine a particular owner of a particular property meets the eligibility criteria. The determination may be made based on the eligibility criteria and the property tax data.

Processing may continue from block S14 to block S16, “Store an identifier of the particular owner and the particular property in the first memory”. At block S16, the report processor may store an identifier of the particular owner and the particular property in the first memory.

Processing may continue from block S16 to block S18, “Generate a notification command, wherein the notification command is effective to initiate the generation of a notification for the particular owner of the particular property”. At block S18, the report processor may generate a notification command. The notification command may be effective to initiate the generation of a notification for the particular owner of the particular property. The notification may inform the particular owner of the particular property of an eligibility to participate in a property tax deferral program.

Processing may continue from block S18 to block S20, “Receive a signal from the owner of the particular property, wherein the signal includes a notification election”. At block S20, the report processor may receive a signal from the owner of the particular property. The signal may include a notification election.

Processing may continue from block S20 to block S22, “Store the notification election in the first memory”. At block S22, the report processor may store the notification election in the first memory.

Processing may continue from block S22 to block S24, “Send the notification election to a tax lien processor, wherein the tax lien processor generates lien data related to a dated municipal tax lien on the property, the dated municipal tax lien is an amount equal to property tax on the property for a pending year and associated fees, and the dated municipal tax lien is structured with interest accruing at specified rates”. At block S24, the report processor may send the notification election to a tax lien processor. The tax lien processor may generate lien data related to a dated municipal tax lien on the property. The dated municipal tax lien may be an amount equal to property tax on the property for a pending year and associated fees. The dated municipal tax lien may be structured with interest accruing at specified rates.

Processing may continue from block S24 to block S26, “Receive the tax lien data from the tax lien processor”. At block S26, the report processor may receive the tax lien data from the tax lien processor.

Processing may continue from block S26 to block S28, “Store the tax lien data in the first memory”. At block S28, the report processor may store the tax lien data in the first memory.

Processing may continue from block S28 to block S30, “Send the lien data to a tax anticipation security processor, wherein the tax anticipation security processor generates tax anticipation security data related to a tax anticipation security based on the lien data, wherein the tax anticipation security is secured by the dated municipal tax lien in an amount equal to the property tax on the property for the pending year, the associated fees, and the interest accrued at the specified rates”. At block S30, the report processor may send the lien data to a tax anticipation security processor. The tax anticipation security processor may generate tax anticipation security data related to a tax anticipation security based on the lien data. The tax anticipation security may be secured by the dated municipal tax lien in an amount equal to the property tax on the property for the pending year, the associated fees, and the interest accrued at the specified rates.

Processing may continue from block S30 to block S32, “Receive the tax anticipation security data”. At block S32, the report processor may receive the tax anticipation security data.

Processing may continue from block S32 to block S34, “Store the tax anticipation security data in the first memory”. At block S34, the report processor may store the tax anticipation security data in the first memory.

Processing may continue from block S34 to block S36, “Generate the report, wherein the report includes data related to the particular owner, the particular property, the tax lien data, and the tax anticipation security data”. At block S36, the report processor may generate the report. The report may include data related to the particular owner, the particular property, the tax lien data, and the tax anticipation security.

Among other potential benefits, a system in accordance with the present disclosure may reduce the cost of tax deferrals for a government entity as the system does not rely on government subsidies or credit. A system in accordance to the present disclosure may eliminate a stigma of a qualification test that may impede many elderly homeowners from taking advantage of a welfare-improving property tax deferral program. A system in accordance to the present disclosure may expand the number of eligible property owners able to take advantage of a welfare-improving property tax deferral program.

Among other potential benefits, a system in accordance with the present disclosure may allow homeowners to defer property tax payments and be charged market based interest rates and not statutorily defined interest rates. A system in accordance to the present disclosure may enable the government entity the option to offer subsidies, guarantees, or other initiatives to enhance eligibility or lower costs for homeowners. A system in accordance to the present disclosure may enable the government entity to use a property tax deferral program as an alternative to the prevalent practice of offering the elderly property tax exemptions or credits under conventional systems and methods. A system in accordance to the present disclosure may provide the government entity valuable information, currently unavailable, on the home equity and eligibility of elderly homeowners for property tax deferrals and may allow for more informed policy-making on offering relief to the elderly homeowners using subsidized or unsubsidized property tax deferrals and/or property tax exemptions or credits.

Among other potential benefits, a system in accordance with the present disclosure may enable a government entity to use a municipal dated lien for a specified amount and create a readily marketable claim. A system in accordance to the present disclosure may create a marketable claim with a duration and risk characteristic that can be assessed and priced in the market far more easily and at a much lower cost than the open-ended property tax deferral liens in conventional tax deferral programs.

Among other potential benefits, a system in accordance with the present disclosure may increase a transparency of the credit quality of property tax deferrals to financial markets. A system in accordance to the present disclosure may prevent property tax deferrals from obscuring the credit quality of a government entity to which property taxes are due, as property tax deferrals in conventional programs may be bundled within that government entity's general finances. A system in accordance to the present disclosure may enable government entities to grant qualifying homeowners property tax deferrals without impairing the government entities' cash flow or credit, unlike conventional tax deferral programs. A system in accordance to the present disclosure may also eliminate the separation between the granting of the property tax deferral and the government entity's receipt of revenue, which may eliminate an uncertainty over if and when the government entity will receive the deferred revenue. A system in accordance to the present disclosure may eliminate considerations and concerns that reduce the inclination of the government entity's current administration to offer homeowners welfare-improving property tax deferrals.

Among other potential benefits, a system in accordance with the present disclosure may allow the funding of separate and distinct property tax deferrals on a single property, each with a separate and distinct interest rate, and each secured by separate and distinct municipal tax lien, with preference given in order of seniority. A system in accordance to the present disclosure may allow annual distinct property tax deferrals on a single property, each year's property tax deferral at a separate and distinct interest rate, and each year's property tax deferral secured by a separate and distinct municipal tax lien, with preference given in order of seniority. A system in accordance to the present disclosure may allow investors to assess the risk of repayment on each deferral on a particular property, and determine terms and conditions for funding the deferral. A system in accordance to the present disclosure may allow investors to provide the government an amount equal to the tax and program costs, in exchange for the proceeds the government receives when the deferred tax amount, program costs, and interest accrued is repaid.

### Example 1

Tax anticipation security processor 165 of issuing entity 175 may generate data for one or more tax anticipation securities (TAS) (e.g., 2017_6574_lowrisk_TAS) to finance a pending year property tax deferrals for duration-risk groups 177. For each duration-risk group 177, tax anticipation security processor 165 of issuing entity 175 may generate and store in tax anticipation security database 170 data related to:
1) A TAS Register (e.g., 2017_6574_lowrisk_register), which may include a record for each deferral that a tax anticipation security finances. A TAS register may
2) include fields that include, but are not limited to, “government_entity”, “property_identifier”, “standardized_property_address”, “original_deferral”, “interest_rate-_margin”, “current_interest_rate_index”, “current_daily_interest_rate”=[(1+“interest_rate_margin”+“current_interest_rate_index”)̂(1/“days”)−1], with days”=if(mod(year,400)=0,366, if(mod(year,100)=0,365, if(mod(year,4)=0,366,365)), “current_lien_amount”, “current_assessed_value”, “current_senior_lien_value”, “current_age_of_youngest_homeowner”, “payments”, “loss”, “active,” “terminated”, “terminated_with_loss”, with known information entered (e.g., the interest rate margin) and “0” entered in the “current_age_of_youngest_homeowner” field.
2) A TAS Transaction Register (e.g., 2017_6574_lowrisk_transactions), which may include a record that records each transaction affecting the tax anticipation security. A TAS transaction register may include fields that include, but are not limited to, “government_entity”, “property_identifier”, “transaction_date”, “payment”, “loss”, “transaction_type” (e.g., payment, disbursement), and “termination”.

Tax anticipation security processor 165 of issuing entity 175 may provide report processor 120 of government entity 180 with tax anticipation security data 172 which may include groups 177. Tax anticipation security data may further include fees for government entity 180 and issuing entity 175 if owners 106 elect to defer taxes on property 108. Fees may fund ongoing servicing costs of a tax anticipation security. Table 1 below, may be an example of information provided in tax anticipation security data 172 sent to report processor 120 by tax anticipation security processor 165. Tax anticipation security processor 165 of issuing entity 175 may provide report processor 120 of government entity 180 with tax anticipation security data 172 which may further include data for each tax anticipation security to be issued to finance the coming year's property tax deferrals, for example:
A GOVERNMENT ENTITY 180 TAS Register and GOVERNMENT ENTITY 180 TAS Transaction Register (e.g., Location_2017_6574_lowrisk_register and Location_2017_6574_lowrisk_transactions), with same fields as files created by issuing entity 175, with known information entered (e.g., “Location” and, in this example, the interest rate margin in the GOVERNMENT ENTITY 180 TAS Register.
A GOVERNMENT ENTITY 180 Database for Processing Property Tax Deferrals for YEAR with fields that include, but are not limited to, the “government entity”, “property_identifier”, “standardized_property_address”, “standardized_owner_address”, “property_type”, “assessed_value”, “property tax due”, “age of youngest homeowner”, “property type eligible”, “owner-occupant eligible”, “age eligible”, “eligible”, “fee1%”, “fee2%”, “fee1 deferred”, “fee2 deferred”, “current lien value”, “prospective value of property tax deferral liens”, “prospective lien percentage”, “duration”, “risk”, “subsidy”, “deferral”, “TAS identifier” “interest rate index”, and “interest margin rate”, with known values entered (e.g., the name of the government entity and the fee1%) and “0” otherwise entered.

TABLE 1
Location Duration-Risk Groups and Rates

Risk

| | | | | |
|---|---|---|---|---|
| Duration | Low | Medium | High | No Credit |

1a. Definition of Duration-Risk Groups by lien-value ratio

| | | | | |
|---|---|---|---|---|
| 65-74 | 0-30% | 30-45% | 45-50% | >50% |
| 75-84 | 0-40% | 40-50% | 50-60% | >60% |
| 85+ | 0-50% | 50-60% | 60-70% | >70% |

1b. Schedule of Interest Rate Margins

| | | | |
|---|---|---|---|
| 65-74 | 3.00% | 3.25% | 3.75% |
| 75-84 | 2.75% | 3.00% | 3.50% |
| 85+ | 2.50% | 2.75% | 3.25% |

1c. Schedule of Initial Interest Rates

Index = 1.35%
Risk

| Duration | Low | Medium | High | No Credit |
|---|---|---|---|---|
| 65-74 | 4.35% | 4.60% | 5.10% | |
| 75-84 | 4.10% | 4.35% | 4.85% | |
| 85+ | 3.85% | 4.10% | 4.60% | |

Report processor 120 of government entity 180 may receive tax anticipation security data 172 from tax anticipation security processor 172 and store in memory 130 the following data: GOVERNMENT ENTITY 180 Database for Processing Property Tax Deferrals for YEAR the “property_identifier”, “standardized_property_address”, “standardized_owner_address”, “property_type”, “assessed_value”, and “property_tax_due” on all properties in the government entity subject to property taxation, by a method chosen by that government entity, from its property taxation records. Report processor 120 may sort the records by “standardized_property_address”.

Report processor 120 may determine each property in the GOVERNMENT ENTITY 180 Database for Processing Property Tax Deferrals for YEAR, on an incremental basis, (utilizing the I^{th} counter or in order of the “standardized_property_address”) for eligibility for property tax deferral, based on entered information. Report processor 120 may determine a property type. If property 108 is a single family, 2-3 family home, or condominium, report processor 120 may set “property type_eligible” indicator at “1”. Report processor 120 may set “property type_eligible” indicator at “−1” if property 108 is not a single family, 2-3 family home, or condominium. Report processor 120 may determine owner occupancy. If a property 108 address and owner 106 address are the same, report processor 120 may set an “owner-occupant eligible” indicator at “1”, if a property 108 address and owner 106 address are not the same, report processor 120 may set “owner-occupant_eligible” indicator at “−1”.

Report processor 120 may determine eligibility with other information. Property tax data 142 may include a Registry of Deeds listing all deeded properties in an area governed by government entity 180. Property tax data may include “standardized_property_address”, “mortgage_liens,” “property_tax_deferral_liens” and “other_liens”. Report processor 120 may add a field “lien_eligible” and sort the data based on “standardized_property_address”. Report processor 120 may determine property tax data includes a mortgage or other lien, other than a property tax deferral lien, and may set an indicator to “−1” in a “lien_eligible” field. Report processor 120 may determine property tax data does not include a mortgage or other lien, other than a property tax deferral lien, and may set indicator to “1” in the “lien_eligible” field. Report processor 120 may update information in the “lien eligible” field in a GOVERNMENT ENTITY 180 Database for Processing Property Tax Deferrals for YEAR, by indexing on “standardized_property_address”.

Report processor 120 may save information in memory 130 in a GOVERNMENT ENTITY 180 Property Tax Deferrals Database. Report processor 120 may determine values used in determining a prospective value of property tax deferral liens and save in memory 130 in the GOVERNMENT ENTITY 180 Database for Processing Property Tax Deferrals for YEAR. Report processor 120 may determine a value for an “age_of_youngest_homeowner” field. The GOVERNMENT ENTITY 180 Property Tax Deferrals Database may be a hierarchical database with files related in a parent-child manner. Parent files in the GOVERNMENT ENTITY 180 Property Tax Deferrals Database may include records for all properties with existing property tax deferrals with fields that include, but are not limited to, “government_entity”, “property_identifier,” “standardized_property_address”, “current_value_of_property_tax_deferral_liens”, and “age_of_youngest_homeowner” (the age of the youngest homeowner on the date property taxes were due in the previous year). The child files for each property in the GOVERNMENT ENTITY 180 Property Tax Deferrals Database may include one record for each property tax deferral lien on that property, with fields that include, but are not limited to, “government_entity”, “property_identifier”, “TAS_identifier” (identifying the TAS that finances the deferral, e.g., 2017_6575_risk_TAS), “property_tax_deferred”, “fee1_deferred” (the deferred fee to issuing entity), “fee2_deferred” (the deferred fee to government entity to which taxes are due), “subsidy”, “original_deferral” (“property_tax_deferred”+“fee1_deferred”+“fee2_deferred”−“subsidy”), “interest_rate_margin”, “current_interest_rate_index”, “current_daily_interest_rate” (as calculated above), “current_lien_value”, and “current_senior_lie_value”. The “senior_lien_value” in each child file is the sum of each “current_lien_value” in prior child records of the same parent. Parent files in the GOVERNMENT ENTITY 180 Property Tax Deferrals Database may include “current_value_of_property_tax_deferral_liens” for a particular property which may be a sum of each “current_lien_value” in each of the parent's child records.

Report processor 120 may determine a “prospective_value_of_property_tax_deferral_liens” for each property 108 in the GOVERNMENT ENTITY 180 Property Tax Deferrals Database by multiplying a value in each “current_lien_value” field by (1+current daily interest rate)̂(days to date when property taxes are due) and report processor 120 may generate a “current_lien_value” in the parent database to date when property taxes are due. Processor 120 may add “1” to a current value in “age_of_youngest_homeowner” field in the parent record to update an “age_of_youngest_homeowner” in the parent records when property taxes are due.

Report processor 120 may determine a GOVERNMENT ENTITY 180 Projected [YEAR] Lien File to include a record for each property 108 with a property tax deferral lien, with each record containing fields that include, but are not limited to, “government_entity”, “property_identifier”, “standardized_property_address”, “age_of_youngest_homeowner” (projected to the date when taxes are due), “age_eligible” (with the value “1” entered), and “current value of property_tax_deferral_liens” (projected to the date that taxes are due). Data files saved in the GOVERNMENT ENTITY 180 Projected [YEAR] Lien File may be sorted by “standardized_property_address”, the information in the “age_of_youngest_homeowner”, “age_eligible”, and “current value of property tax deferral liens”. Report processor 120 may not save changes to the GOVERNMENT ENTITY 180 Property Tax Deferrals Database.

Report processor 120 may determine properties 108 as eligible, ineligible, and potentially eligible properties. Report processor 120 may determine “eligible” variable=“1” (eligible) if all “CHARACTERISTIC eligible” variables=“1”; “−1” (ineligible) if any CHARACTERISTIC_eligible” variable=“−1”; and otherwise=“0” (potentially_eligible). Potentially eligible properties 108 may be properties where the age of the youngest homeowner is unknown, but are otherwise eligible.

Report processor 120 of government entity 180 may enter, in each record for an eligible or potentially eligible property 108 (i.e., “eligible”=0 or 1) in a GOVERNMENT ENTITY 180 Database for Processing Property Tax Deferrals for YEAR, a field “fee2%” which may be a program fee percentage to be charged The fee may be a percentage of property tax due on property 108 and the fee may fund current and ongoing servicing costs. Report processor 120 may enter, in each record in each GOVERNMENT ENTITY 180 Database for Processing Property Tax Deferrals for YEAR:
a. In the fields “fee1 deferred” and “fee2 deferred”, “fee1 deferred”=“fee1%”×“property tax due” and “fee2 deferred”=“fee2%”×“property tax due”.
b. In the field “prospective value of property tax deferral liens”=“current value of property tax deferral liens” (projected to the date that taxes are due)+“property tax due”+“fee1 deferred”+“fee2 deferred”−“subsidy” (which is initially=0).
c. In the field “prospective lien percentage”=“prospective value of property tax deferral liens”/“assessed_value”.

Report processor 120 may sort eligible and potentially eligible properties 108 (i.e., “eligible”=0 or 1) in each GOVERNMENT ENTITY 180 Database for Processing Property Tax Deferrals for YEAR into groups 177. Groups 177 may be based on the age of the youngest owner 106, at ages 65 to 74, 75 to 84, and 85 or over. If the “eligible” indicator=“1” or “0”, report processor 120 may determine if the youngest owner 106 is between 65 and 74; and if so, report processor 120 may enter “6574” in the “duration” field. Report processor 120 may determine an age of the youngest owner 106 is between 74 and 85; and if so, “7485” report processor 120 may enter in the “duration” field. Report processor 120 may determine an age of the youngest owner 106 is 85 or older; and if so, report processor 120 may enter “85” in the “duration” field. Report processor 120 may not be able to determine an age of youngest owner 106, and if so, may enter “age unknown” in the “duration” field.

Report processor 120 may sort properties 108 into risk groups 154 within each group 177 according to ratio of prospective property deferral liens to the assessed value of property 108. Data related to eligibility characteristics for properties 108 that have an existing property tax deferral lien may be accessible to report processor 120. Potentially eligible properties 108 (i.e., “eligible”=0) which have no property tax deferrals, may be determined as low risk by report processor 120 and report processor 120 may enter “low” in the “risk” field. Report processor 120 may determine duration for property 108 if property 108 has a previous property tax deferral. For example, processor may determine property 108 (i.e., “eligible”=1) and “duration group 177”=“6574”. Report processor 120 may determine “duration group 177”=“7584”. Report processor 120 may determine “duration group 177”=“84”. Report processor 120 may determine when “prospective lien percentage” is less than an specified amount for the particular group 177 for government entity 180, “low” may be entered in the “risk” field. Report processor 120 may determine when “prospective lien percentage” is less than a higher specified amount for the particular group 177 for government entity 180, “medium” may be entered in the “risk” field. Report processor 120 may determine when “prospective lien percentage” is less than a higher specified amount for the particular group 177 for government entity 180, “high” may be entered in the “risk” field. Report processor 120 may determine when “prospective lien percentage” is more than a higher specified amount for the particular group 177 for government entity 180 “no funding” may be entered in the “risk” field. Each risk group 154 that can be financed may be associated with a particular group of tax anticipation securities with a particular interest rate index and interest rate margin. Report processor 120 may enters a TAS identifier or “no TAS available” as the “TAS identifier” (e.g., 2017_6574_lowrisk_TAS), the interest rate index or “no credit available” as the “interest rate index,” and the interest rate margin or “no credit available” as the “interest margin rate”.

An example a GOVERNMENT ENTITY 180 Report indicating the availability of property tax deferrals, and the interest rates charged, for properties 108 subject to taxation where the duration and risk categories of the deferrals are known, is illustrated in Table 2 below:

TABLE 2
Location Distribution of Deferrals Report
Initial Distribution of Deferrals

Risk

| Age | | | Low | Medium | High | No Credit |
|---|---|---|---|---|---|---|
| 65 | - | 74 | 475 | 132 | 0 | |
| 75 | - | 84 | 427 | 276 | 164 | 26 |
| 85 | + | | 364 | 428 | 128 | 32 |

Government entity 180 may test the ability of offering subsidies to expand eligibility and/or make deferrals available on more advantageous terms, to specific groups of owners. Processor 180 may enter a value in the “subsidy” field (e.g., based on the “duration”, “assessed value”, and/or a “prospective lien percentage” calculated without a subsidy) and generate the GOVERNMENT ENTITY 180 Report indicating the availability of property tax deferrals and the interest rates charged for properties subject to taxation where the factors determining the subsidies are known, as shown in Table 3 below. Government entity 180 may utilize table 3 to decide whether to offer subsidies, and what those subsidies may be.

TABLE 3
Distribution of Deferrals with subsidy

Risk

| Age | | | Low | Medium | High | No Credit |
|---|---|---|---|---|---|---|
| 65 | − | 74 | 475 | 132 | 0 | |
| 75 | − | 84 | 427 | 276 | 177 | 13 |
| 85 | + | | 364 | 428 | 149 | 11 |

Subsidy

| | |
|---|---|
| Average amount | $759 |
| Owners effected | 34 |
| Cost | $25,806 |

Report processor 120 may generate a notification command 148 to initiate a generation of an eligibility notification 151 for each property owner 106 eligible or potentially eligible for property tax deferral. Eligibility notification 151 may presenting an option, or potential option, for an owner 106 to defer payment of taxes on property 180 for a coming year. Eligibility notification 151 may be delivered to owner 106 by a specified date which may be sufficiently prior to the date taxes are due to allow property owner 106 time to gather needed information to make an informed decision and to inform government entity 180 of an election to defer paying a coming year's property tax. In an example, eligibility notification 151 may be delivered with the tax bill for property 108.

Eligibility notification 151 may include information in the records of government entity 180 upon which an offer to defer property tax for a given year may be made (e.g., the names of the current homeowners, the age of the youngest homeowner, the property type, the total value of property tax deferrals secured by liens on the property, and the lack of other liens on the property). Eligibility notification 151 may include information which should be certified as correct by property owner 106. Eligibility notification 151 may relate that owner 106 is eligible to defer the coming year's property taxes for a specified program fee. Eligibility notification 151 may include information related to a net of any subsidy, the value of the property tax deferred and program fee, accruing interest at a specified rate and beginning on the date taxes are due. Eligibility notification 151 may include a statement that if the stated conditions are not correct, the ability of owner 106 to defer payment of taxes on property 108, and the terms and conditions, could change.

Eligibility notification 151 may include the conditions necessary for eligibility and may state that the records of government entity 180 indicate that some but not all of these conditions are satisfied. Eligibility notification 151 may request known and unknown conditions be reported by owner 106 (e.g., the property type, owner-occupancy, the total value of property tax deferrals secured by liens on the property, and the lack of other liens on the property). Eligibility notification 151 may indicate that based on the known conditions owner 106 may be eligible to defer the coming year's taxes on property 108, but eligibility depends on one or more unknown conditions (e.g., the age of the youngest homeowner), and that if owner 106 provides specified evidence that the condition is satisfied (e.g., a copy of their driver's license), owner 106 may elect to defer the coming year's taxes on property 108.

Eligibility notification 151 may include terms and conditions of the deferral based on eligibility conditions; that the obligation to repay the property tax deferred, plus the program fee and accrued interest, will be secured by a lien on property 108; that the obligation can be repaid or reduced, and the lien removed or reduced, at any time; that owner 106 has no obligation to repay the obligation so long as they reside in property 108; and that the obligation is a non-recourse obligation, secured only by the equity of owner 106 in property 108. Eligibility notification 151 may indicate that to defer taxes on property 108 for the coming year, owner 106 is required, by a specified date to, 1) inform government entity 120 that owner 106 intends to defer their payment of taxes on property 108; 2) provide evidence that owner 106 satisfies eligibility conditions not known to government entity 180; 3) correct any information stipulated in eligibility notification 151; and 4) attest, under specified penalties, that the eligibility conditions specified in eligibility notification 151 are correct or, if corrected, are accurate, do not void eligibility, and that owner 106 accepts the terms and conditions specified for the conditions as corrected.

Report processor 120 may receive election 150 indicating intent of owner 106 to participate in a tax deferral. Report processor 120 may receive election 150 by a date specified by government entity 180. Report processor 120 may update information related to owner 106 and property 108 is election 150 includes corrected information provided by owner 106. Report processor 120 may update duration, risk classification, and terms and conditions of the deferral for owner 106 and property 108 dated based on the corrected information. Report processor 120 may entered the election for owner 106 and property 108 into the GOVERNMENT ENTITY 180 Database for Processing Property Tax Deferrals for YEAR by setting the “deferral” indicator for property 108 to “1”.

Report processor 120 may send election 150 to tax lien processor 155. In response, tax lien processor 155 may generate lien data 162 for property 108. Tax lien processor 155 may file a dated municipal tax lien by a specified date on property 108 of owner 106 electing a deferral. The dated municipal tax lien may be in an amount equal to the tax payment for property 108 and associated deferral fees, less any subsidy. The dated municipal tax lien may accrue interest at the rate specified in eligibility notice 151, commencing on the date property taxes are due. Enforcement of the dated municipal tax lien may be suspended by government entity 180. The dated municipal tax lien may be junior to any earlier liens and senior to any subsequent liens. Tax lien processor 155 may send lien data 162 to report processor 120.

Report processor 120 may output a YEAR GOVERNMENT ENTITY 180 Property Tax Deferral Financing File (e.g., “2017_Location Property Tax Deferral Financing File”) for government entity 180 to which taxes are due from the GOVERNMENT ENTITY 180 Database for Processing Property Tax Deferrals for YEAR. On an incremental basis report processor 120 may check each property 108 record in the GOVERNMENT ENTITY 180 Database for Processing Property Tax Deferrals for YEAR (utilizing the I^{th} counter or in order of the designated property identification number) deferral status. If the “deferral” indicator is equal to “1”, report processor 120 may create an identical record in the file the GOVERNMENT ENTITY 180 YEAR Property Tax Deferral Financing File.

Report processor 120 may use the GOVERNMENT ENTITY 180 YEAR Property Tax Deferral Financing File to populate the GOVERNMENT ENTITY 180 YEAR TAS Registers. On an incremental basis, report processor 120 may use “TAS_identifier” in each property 108 record in the GOVERNMENT ENTITY 180 YEAR Property Tax Deferral Financing File to identify a corresponding the GOVERNMENT ENTITY 180 YEAR TAS Register in which to register financing of the property tax deferral on property 108 (e.g., the Location_2017_6574_lowrisk_register). Report processor 120 may create a new record in the GOVERNMENT ENTITY 180 YEAR TAS Register that registers the deferral, and processor 180 may enter information from the GOVERNMENT ENTITY 180 YEAR Property Tax Deferral Financing File in the fields “government entity”, “property_identifier”, “standardized_property_address”, “original deferral”, “interest rate margin”, “current lien amount” (=“original deferral”), “current assessed value” (=“assessed_value”), “current senior lien value” (=“prospective value of property tax deferral liens”−“deferral”), and “current age of youngest homeowner”. Report processor 120 may enter a current value of the TAS interest rate index in the “current interest rate index” field and “1” in the “actives” field. Report processor 120 may send the GOVERNMENT ENTITY 180 YEAR TAS Register to tax anticipation security processor 165.

Tax anticipation security processor 165 may populate TAS Registers for each of the TAS issued in a given year (e.g., the 2017_6574_lowrisk_TAS Register) by merging the GOVERNMENT ENTITY 180 TAS Registers for each YEAR GROUP 177 RISK GROUP 154 TAS. Tax anticipation security processor 165 may:
a. Determine a total amount to be raised by each YEAR group 177 risk group 154 TAS group by summing the “original_deferral” amounts in each YEAR GROUP 177 RISK GROUP 154 TAS Register.
b. Generate a Period TAS Reporting File (e.g., 2017_6574_lowrisk_TAS_Period_Reporting_File), with fields that include, but are not limited to “period”, “current lien value”, “payments”, “losses”, “actives”, “terminations”, and “terminations with loss”.
c. Generate a record in each Period TAS Reporting File and enters in the “period” field “Q0”, in the “current lien value” field the sum of the values in the “current lien value” fields in the TAS's TAS Register, and in the “actives” field the sum of the values in the “active” fields the TAS's TAS Register.

Tax anticipation processor 165 may issue one or more YEAR group 177 risk group 154 TAS (e.g. 2017_6574_low_risk_TAS) for each “duration-risk group” for funding property tax deferrals. For each TAS group, an amount raised may be a sum of the “original deferral” amounts in the particular YEAR GROUP 177 RISK GROUP 154 TAS Register, and the interest rate may be an amount specified in the “current interest rate” field, based on the values in the “interest rate margin” and “current index rate” fields, set on the specified date. Issued TAS may be secured by the dated municipal tax liens specified in the particular YEAR GROUP 177 RISK GROUP 154 TAS Register.

Tax anticipation processor 165 may receive monies from each issued TAS. Tax anticipation processor 165 may deposited in an account the “fee1 deferred” amount determined above, to finance its program costs. Tax anticipation processor 165 may send to government entity 180 the amount entered in the “total property tax deferral financing” field, less the amount entered in the “fee1 deferred” field, in a GOVERNMENT ENTITY 180 YEAR Property Tax Deferral Financing File.

Report processor 120 of government entity 180, upon receiving the funds from tax anticipation security processor 165 of issuing entity 175, may deposit the funds and enter the amount as a credit in government entity 180 general account. Monies deposited in government entity 180 general account may be assets of government entity 180 and may not satisfy the dated municipal tax lien, and may not halt the accrual of interest at the specified rates. Monies received by report processor 120 and government entity 180 may be accessible and available for withdrawal and use by government entity 180, even while the property tax associated with the monies is deferred. In response to receiving the monies, an obligation may be created for government entity 180 to repay the at least one TAS holder upon the occurrence of a trigger event. A trigger event may include a payment by owner 106 of property 108 (a payment towards a lien or property tax), property 108 being sold, or property 108 being foreclosed upon in the event property 108 is abandoned, delinquent in property tax payment, and/or qualifying owner 106 becoming deceased. Government entity 180 may be obliged to repay the at least one tax anticipation security holder a limited amount equal to monies received minus specified costs after the satisfaction of all senior liens associated with property 108.

Report processor 120 may update the GOVERNMENT ENTITY 180 Property Tax Deferrals Database on a date when property taxes are due. Report processor 120 may save into memory 130 the GOVERNMENT ENTITY 180 Property Tax Deferrals Database and the GOVERNMENT ENTITY 180 YEAR Property Tax Deferral Financing File for each government entity 180 to which taxes are due that may participates in the program. Processor 180 may save the GOVERNMENT ENTITY 180 YEAR Property Tax Deferral Financing File in memory 130 on an incremental basis, in order of the designated “property_identifier” in the GOVERNMENT ENTITY 180 YEAR Property Tax Deferral Financing File based on:
a. If there is no parent record for the property in the GOVERNMENT ENTITY 180 Property Tax Deferrals Database, report processor 120 may create a new parent record with populated fields that include, but are not limited to, “government entity”, “property identifier,” “standardized_property_address”, and “age of youngest homeowner”, plus an unpopulated “current value of property tax deferral liens” field, whose value is calculated from the child files. It creates a child file for that property and creates a “[YEAR] [property_identifier]” child record in that file and enters the fields “government entity”, “property_identifier”, “TAS identifier”, “property tax deferred”, “fee1 deferred”, “fee2 deferred”, “subsidy”, “original deferral”, “interest rate margin”, “current interest rate index”, “current daily interest rate”, and “current lien value”, with values entered from the “property_identifier” record in the GOVERNMENT ENTITY 180 YEAR Property Tax Deferral Financing File.
b. If there is a parent record for the property in the GOVERNMENT ENTITY 180 Property Tax Deferrals Database, report processor 120 may: 1) update each “age of youngest homeowner” in the parent property record in the GOVERNMENT ENTITY 180 Property Tax Deferrals Database to the higher of 1+the current value in the field or the value in the “age of youngest homeowner” field in the “property_identifier” record in YEAR Property Tax Deferral Financing File; 2) create a new “YEAR_property 108 identifier” child file record, appended at the end of the child file for the property identified by the “property_identifier”, and enters the fields “government entity”, “property_identifier”, “TAS identifier”, “property tax deferred”, “fee1 deferred”, “fee2 deferred”, “subsidy”, “original deferral”, “interest rate margin”, “current interest rate index”, “current daily interest rate”, and “current lien value”, with values entered from the “property_identifier” record in the GOVERNMENT ENTITY 180 YEAR Property Tax Deferral Financing File; and 3) determine, in each child record, a sum of each “current_lien_value” in each prior child file and enter that value in the “current senior lien value”; generate a sum of each “current_lien_value” in each child file and enter that value in the “current lien value” in the parent record.

Report processor 120 may update “current lien value” in each record in each a) GOVERNMENT ENTITY 180 TAS Register; b) TAS Register; and c) child record in each GOVERNMENT ENTITY 180 Property Tax Deferrals Database. Report processor 120 may update “current lien value” on a daily basis by the “daily interest rate,” which may include increments of each “prior lien value” in each child record and the “current value of property tax deferral liens” in each parent record in each GOVERNMENT ENTITY 180 Property Tax Deferrals Database.
a. On a specified date each year, report processor 120 may update “current interest rate index” in each child file to the value of a specified index. In an example, the index for a deferral may be the one-year Constant Maturity Treasury interest rate.

In an example, government entity 180 may receive funds to reduce or satisfy the deferred property tax obligation on PROPERTY_IDENTIFIER property 108. If the funds are received by government entity 180 as the result of a trigger event that terminates the deferral (e.g., the sale of the property), all municipal property tax liens on the property may be removed upon receipt of the funds. The receipt of funds may be recorded by report processor 120 in a new record in a GOVERNMENT ENTITY 180 Lien Payment Processing File (e.g., Location LienPayment Processing File), with fields that include, but are not limited to, “government entity”, “property_identifier”, “transaction_date”, “payment”, “transaction amount remaining” (initially the funds received), and “termination”. If the funds received are the result of a “trigger event” that terminates the deferral, “1” is entered in the “termination” field.

Report processor 120 of government entity 180 may receive funds that reduce or satisfy deferred property tax obligations, and may process the received funds by: 1) recording the receipt of funds in the GOVERNMENT ENTITY 180 Lien Payment Processing File; 2) recording the funds in the child file records in the GOVERNMENT ENTITY 180 Property Tax Deferrals Database for property 108 identified by the “property_identifier” in the GOVERNMENT ENTITY 180 Lien Payment Processing File record; and 3) recording a GOVERNMENT ENTITY 180 TAS Transactions Processing File, with fields that include, but are not limited to, “government entity”, “TAS identifier”, “transaction_date”, “property_identifier”, “payment”, “termination”, and “loss”.

Report processor 120 may update on an incremental basis, in ascending order by date, a value in the “current lien value” field in the earliest record in the “property_identifier” child file in the Property Tax Deferrals Database to the value in the “transaction amount remaining” field in the record recording the receipt of the funds in the GOVERNMENT ENTITY 180 Lien Payment Processing File. If the value in the “transaction amount remaining” field in GOVERNMENT ENTITY 180 Lien Payment Processing File record is greater than or equal to the value in the “current lien value” child file record, report processor 120 may:
i) Create a record in the GOVERNMENT ENTITY 180 TAS Transactions Processing File and enter in that record:
   (1) the values in the “transaction_date” and “property_identifier” fields in the GOVERNMENT ENTITY 180 Lien Payment Processing File record into the “transaction_date” and “property identifier” fields of the GOVERNMENT ENTITY 180 TAS Transactions Processing File.
   (2) the values in the “tab identifier” and “current lien value” in the child file record in the GOVERNMENT ENTITY 180 Property Tax Deferrals Database into the “tab identifier” and “payment” fields of the GOVERNMENT ENTITY 180 TAS Transactions Processing File.
ii) Transfer the amount entered in the “payment” field to the transaction account of the TAS identified by the “tab identifier” held by the issuing entity.
iii) Reset
   (1) The value in the “transaction amount remaining” field in the GOVERNMENT ENTITY 180 Lien Payment Processing File record as the value in the “transaction amount remaining” minus the value in the “current lien value” field in the child file record in the Property Tax Deferrals Database.
   (2) The value in the “current lien value” field in the child file record in the Property Tax Deferrals Database to “0”.
iv) If the value in the “termination” field in the GOVERNMENT ENTITY 180 Lien Payment Processing File record is “1”, report processor 120 may enter “1” in the “termination” field and “0” in the “loss” field in the GOVERNMENT ENTITY 180 TAS Transactions Processing File and report processor 120 may delete the record the child file in GOVERNMENT ENTITY 180 Property Tax Deferrals Database.

If the value in the “transaction amount remaining” field in the GOVERNMENT ENTITY 180 Lien Payment Processing File record is less than the value in the “current lien value” child file record, report processor 120 may:
i) Create a record in GOVERNMENT ENTITY 180 TAS Transactions File and enter in that record:
   (1) the values in the “transaction_date” and “property_identifier” fields in GOVERNMENT ENTITY 180 Lien Payment Processing File record into the “transaction_date” and “property identifier” fields of GOVERNMENT ENTITY 180 TAS Transactions File record.
   (2) the values in the “tab identifier” in the child file record in GOVERNMENT ENTITY 180 Property Tax Deferrals Database into the “tab identifier” field in the child file record in the GOVERNMENT ENTITY 180 TAS Transactions File.
   (3) In the “payment” field, the value in the “transaction amount remaining” field in the GOVERNMENT ENTITY 180 Lien Payment Processing File.
ii) Transfer the amount entered in the “payment” field to the transaction account of the TAS identified by the “tab identifier” held by issuing entity 175.
iii) Reset:
   (1) The value in the “transaction amount remaining” field in GOVERNMENT ENTITY 180 Lien Payment Processing File to “0”.
   (2) The value in the “current lien value” field in the child file in GOVERNMENT ENTITY 180 Property Tax Deferrals Database to the value in the “current lien value” field less the value in the “transaction amount remaining” field in GOVERNMENT ENTITY 180 Lien Payment Processing File record.
iv) If the value in the “termination” field in GOVERNMENT ENTITY 180 Lien Payment Processing File record is “1”, in the GOVERNMENT ENTITY 180 TAS Transactions Processing File “1” is entered in the “termination” field and the amount in the “current lien value” field in the child file is entered in the “loss” field; then the record the child file record is deleted. Report processor 120 may proceed to the next oldest deferral in the “PROPERTY IDENTIFIER” child database.

Report processor 120 may updates GOVERNMENT ENTITY 180 TAS Transactions Registers; GOVERNMENT ENTITY 180 TAS Registers; TAS Transactions Registers; and TAS Registers on a daily basis using the records entered that day in GOVERNMENT ENTITY 180 TAS Processing File. Report processor 120 may copy each record entered in a day in each GOVERNMENT ENTITY 180 TAS Processing File, to a DAY TAS Processing File (e.g., January_15_2017 TAS Processing File). Report processor 120 may sort the records in the DAY TAS Processing File by “TAS_identifier”, then by “government_entity,” then by “property_identifier”. On an incremental basis, beginning with the first record in a DAY TAS Processing File, report processor 120 may:
a. Load into memory 130 GOVERNMENT ENTITY TAS Transactions Register for the TAS and government entity 180 identified in the “tab_identifier” and “government entity” fields in the DAY TAS Processing File record. Report processor 120 may create a record in the GOVERNMENT ENTITY 180 TAS Transactions Register and enter the information in the “property_identifier”, “transaction_date”, “payment”, “loss”, and “termination” fields from the DAY Lien Payment Processing File record to the GOVERNMENT ENTITY 180 TAS Transactions Register record. Report processor 120 may save the updated GOVERNMENT ENTITY 180 TAS Transactions Register.
b. Load into memory 130 the GOVERNMENT ENTITY 180 TAS Register for the TAS and government entity 180 identified in the “tab_identifier” and “government entity” fields in the DAY TAS Processing File record. Report processor 120 may identify the record for the property 108 identified in the “property_identifier” field in the DAY TAS Processing File record, and add the amount in the “payment” and “loss” fields in the DAY TAS Processing File to the amounts in the “payments” and “loss” fields in the GOVERNMENT ENTITY 180 TAS Register respectively, and subtract those values from the value in the “current_lien_value” field in the GOVERNMENT ENTITY 180 TAS Register. If the value in the “termination” field in the DAY TAS Processing File is “1” in the GOVERNMENT ENTITY 180 TAS Register report processor 120 may reset the value in the “termination” field to “1”; and if the value in the “loss” field in the DAY TAS Processing File is greater than zero, report processor 120 may reset the value in the “terminated with loss” field to “1”. Report processor 120 may save the updated GOVERNMENT ENTITY 180 TAS Register in memory 130.
c. Load into memory 130 the TAS Transactions Register for the tax anticipation security identified in the “tab_identifier” field in the DAY TAS Processing File record. Report processor 120 may create a record in this TAS Transactions Register and enter the information in the “government entity”, “property_identifier” “payment”, “loss”, and “termination” fields in the DAY TAS Processing File record to the TAS Transactions Register record. Report processor 120 may save the updated TAS Transactions Register.
d. Load into memory 130 the TAS Register for the tax anticipation security and government entity 180 identified in the “tab_identifier” and “government entity” fields in the [DAY] TAS Processing File record. Report processor 120 may identify the record for property 108 identified in the “property_identifier” field, and add the amount in the “payment” and “loss” fields in the DAY TAS Processing File to the amounts in the “payments” and “loss” fields in the TAS Register record and subtract those values from the value in the “current_lien_value” field in the TAS Register respectively. If the value in the “termination” field in the DAY TAS Processing File is “1”, report processor 120 may reset the value in the “active” field in the TAS Register record to “0” and the value in the “terminated” field to “1”. If the value in the “loss” field in the DAY TAS Processing File is greater than zero, report processor 120 may enter “1” in the “terminated with loss” field in the TAS Register record. Report processor 120 may save the updated TAS Register to memory 130.
e. Report processor 120 may proceed to the next record in the DAY TAS Processing File.

Report processor 120 may, at the end of each day for each tax anticipation security (e.g., the 2017 6574_lowrisk_TAS):
a. Transfer the funds in the TAS's Transaction Account to the TAS holders or to their trustees, agents, or custodian.
b. Create a record in the TAS Transaction Register, entering the date in the “date” field, the amount disbursed in the “payment” field, and “disbursement” in the “transaction_type” field.

At step 130, at a specified periodic reporting date (e.g., at the end of a quarter), the calculation:
a) Creates a record in each TAS's Period TAS Reporting File, entering in the “period” field the period just ending (e.g., Q1_2018), in the “current lien value”, “payments”, “losses”, “actives”, “terminations”, and “terminations with loss” fields the sum of the values in those fields in the TAS's TAS Register.
c. Creates a report to TAS holders of each TAS that provides the information on the period, and changes from the previous period and the same period in the previous year, on the values recorded in each TAS's Period TAS Reporting File.

Report processor 120 may update the assessed values of the properties 108 in the GOVERNMENT ENTITY 180 Property Tax Deferrals Database at a specific periodic date. In an example, tax anticipation security processor 165 may an annual report on a financial status of each tax anticipation security on a specific date (e.g., the last day of the year). The annual report may include, among other information, a current value of liens backing the tax anticipation security, disbursements over the prior year; losses due to terminations over the prior year; and the number of liens that are active, terminated, and terminated with losses, using information from the Period TAS Reporting Files. The annual report may also include, for each dated municipal tax lien securing the tax anticipation security, a current value of the lien, the assessed value of property 108, total value of all senior liens on property 108, a location of property 108, and the age of the youngest owner 106, using information from the GOVERNMENT ENTITY 180 Property Tax Deferrals Databases.

As would be appreciated by one skilled in the art, any combination of the steps in system 100 can be implemented utilizing any suitable computing device and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 110 is depicted in FIG. 1. The computing device 110 is merely an illustrative example of a suitable computing environment and in no way limits the scope of the present disclosure. A “computing device”, as represented by FIG. 1, can include a “workstation”, a “server”, a “laptop”, a “desktop”, a “hand-held device”, a “mobile device”, a “tablet computer”, or other computing devices, as would be understood by those of skill in the art. Given that the computing device 110 is depicted for illustrative purposes, embodiments may utilize any number of computing devices 110 in any number of different ways to implement a single embodiment. Accordingly, embodiments are not limited to a single computing device 110, as would be appreciated by one with skill in the art, nor are they limited to a single type of implementation or configuration of the example computing device 110.

Computing device 110 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the computing device 110.

Memory 130 can include computer-storage media in the form of volatile and/or nonvolatile memory. Memory 130 may be removable, non-removable, or any combination thereof. Exemplary hardware devices are devices such as hard drives, solid-state memory, optical-disc drives, and the like. Computing device 110 may include one or more processors 120 that may read data from components such as the memory 130 and various I/O components, etc. Display 125 may present data indications to a user or other device. Exemplary presentation components include a display device, speaker, printing component, vibrating component, etc. The I/O ports may enable computing device 110 to be logically coupled to other devices, such as I/O components 220. Some I/O components may be built into computing device 110. Examples of such I/O components may include a microphone, joystick, recording device, game pad, satellite dish, scanner, printer, wireless device, networking device, etc.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system to generate a report, the system comprising:
a report processor in communication with a first memory;
a property tax processor in communication with a property tax database;
an underwriter risk assessment generator;
a tax lien processor; and
a tax anticipation security processor;
wherein the report processor is in communication with the property tax processor, the underwriter risk assessment generator, the tax lien processor, and the tax anticipation security processor over a network;
the underwriter risk assessment generator configured to:
generate credit data related to credit availability;
generate interest data related to an interest rate; and
send the credit data related to credit availability and the interest data related to the interest rate to the report processor;
the report processor configured to:
receive the credit data related to credit availability and the interest data related to the interest rate from the underwriter risk assessment generator;
store the credit data and the interest data in the first memory;
determine eligibility criteria for a program based on the credit data and the interest data;
store the eligibility criteria in the first memory;
the property tax processor configured to:
generate property tax data based on data in a property tax database, wherein the property tax data includes data related to properties within an area governed by a government entity, owners of properties within the area governed by the government entity, and taxes due on the properties within the area governed by the government entity for a year;
send the property tax data to the report processor;
the report processor further configured to:
receive the property tax data;
store the property tax data in the first memory;
determine that a particular owner of a particular property meets the eligibility criteria based on the eligibility criteria and the property tax data;
store an identifier of the particular owner and the particular property in the first memory;
generate a notification command, wherein the notification command is effective to initiate a generation of an eligibility notification for the particular owner of the particular property;
receive a signal from the particular owner of the particular property, wherein the signal includes a notification election;
store the notification election in the first memory;
send the notification election to the tax lien processor;
the tax lien processor configured to:
receive the notification election;
generate lien data related to a dated municipal tax lien on the property, wherein the dated municipal tax lien is an amount equal to property tax on the particular property for a pending year and associated fees, and the dated municipal tax lien is structured with interest accruing at specified rates;
send the lien data to the report processor;
the report processor further configured to:
receive the lien data;
store the lien data in the first memory;
send the lien data to the tax anticipation security processor;
the tax anticipation security processor configured to:
receive the lien data;
generate tax anticipation security data related to a tax anticipation security based on the lien data, wherein the tax anticipation security data relates to a tax anticipation security which is secured by the dated municipal tax lien in an amount equal to the property tax on the particular property for the pending year, the associated fees, and the interest accrued at the specified rates;
send the tax anticipation security data to the report processor;
the report processor further configured to:
receive the tax anticipation security data;
store the tax anticipation security data in the first memory; and
generate the report, wherein the report includes data related to the particular owner, the particular property, the tax lien data, and the tax anticipation security data.

2. The system of claim 1, wherein the dated municipal tax lien data is related to a dated municipal tax lien that is junior to any earlier municipal tax liens on the particular property and senior to any subsequent liens on the particular property.

3. The system of claim 1, wherein the eligibility criteria includes a determination that the particular owner has adequate equity in the particular property.

4. The system of claim 1 wherein the tax anticipation security data relates to a tax anticipation security which, upon being generated, includes an obligation of the government entity to pay the tax anticipation security upon an occurrence of a trigger event.

5. The system of claim 4, wherein the trigger event includes one of:
a payment from the particular owner of the particular property;
the particular property being sold; or
a foreclosure of the particular property in the event the particular property being abandoned, delinquent in property tax payment, and/or the death of the particular owner.

6. The system of claim 1, wherein the interest rate is based on an expected duration of repayment of the dated municipal tax lien, risk characteristics of the repayment of the dated municipal tax lien, and/or an ability to group tax anticipation securities of similar expected duration and risk characteristics.

7. The system of claim 6, wherein the expected duration of repayment of the dated municipal tax lien is based at least in part on an age of the particular owner.

8. The system of claim 6, wherein the risk characteristics are based at least in part on a ratio of equity in the property to an assessed value of the property, potential changes in a property value associated with the property, a current interest rate, and/or expected changes in interest rates.

9. The system of claim 1, wherein the tax anticipation security processor issues an annual report on a financial status of the tax anticipation security at a specified date.

10. A method to generate a report, the method comprising, by a report processor:
receiving credit data related to credit availability and interest data related to an interest rate from an underwriter risk assessment generator;
storing the credit data and the interest data in a first memory;
determining eligibility criteria for a program based on the credit data and the interest data;
storing the eligibility criteria in the first memory;
receiving property tax data from a property tax processor;
storing the property tax data in the first memory;
determining a particular owner of a particular property meets the eligibility criteria based on the eligibility criteria and the property tax data;
storing an identifier of the particular owner and the particular property in the first memory;
generating a notification command, wherein the notification command is effective to initiate the generation of a notification for the particular owner of the particular property;
receiving a signal from the owner of the particular property, wherein the signal includes a notification election;
storing the notification election in the first memory;
sending the notification election to a tax lien processor, wherein the tax lien processor generates lien data related to a dated municipal tax lien on the property, the dated municipal tax lien is an amount equal to property tax on the property for a pending year and associated fees, and the dated municipal tax lien is structured with interest accruing at specified rates;
receiving the tax lien data from the tax lien processor;
storing the tax lien data in the first memory;
sending the lien data to a tax anticipation security processor, wherein the tax anticipation security processor generates tax anticipation security data related to a tax anticipation security based on the lien data, wherein the tax anticipation security is secured by the dated municipal tax lien in an amount equal to the property tax on the property for the pending year, the associated fees, and the interest accrued at the specified rates;
receiving the tax anticipation security data;
storing the tax anticipation security data in the first memory; and
generating the report, wherein the report includes data related to the particular owner, the particular property, the tax lien data, and the tax anticipation security data.

11. The method of claim 10, wherein the dated municipal tax lien data is related to a dated municipal tax lien that is junior to any earlier municipal tax liens on the particular property and senior to any subsequent liens on the particular property.

12. The method of claim 10, wherein the eligibility criteria includes a determination that the particular owner has adequate equity in the particular property.

13. The method of claim 10, wherein the tax anticipation security data relates to a tax anticipation security which, upon being generated, includes an obligation of the government entity to pay the tax anticipation security upon an occurrence of a trigger event.

14. The method of claim 13, wherein the trigger event includes one of:
a payment from the particular owner of the particular property;
the particular property being sold; or
a foreclosure of the particular property in the event the particular property being abandoned, delinquent in property tax payment, and/or the death of the particular owner.

15. The method of claim 10, wherein credit availability and the interest rate is based on an expected duration of repayment of the dated municipal tax lien, risk characteristics of the repayment of the dated municipal tax lien, and/or an ability to group tax anticipation securities of similar expected duration and risk characteristics.

16. The method of claim 15, wherein the expected duration of repayment of the dated municipal tax lien is based at least in part on an age of the particular owner.

17. The method of claim 16, wherein the risk characteristics are based at least in part on a ratio of equity in the property to an assessed value of the property, potential changes in a property value associated with the property, a current interest rate, and/or expected changes in interest rates.

18. A device to generate a report, the device comprising:
a report processor in communication with a first memory, wherein the memory includes instructions, the report processor configured to execute the instructions to:
receive credit data related to credit availability and interest data related to an interest rate from an underwriter risk assessment generator;
store the interest data in a first memory;
determine eligibility criteria for a program based on the credit data and the interest data;
store the eligibility criteria in the first memory;
receive property tax data from a property tax processor;
store the property tax data in the first memory
determine a particular owner of a particular property meets the eligibility criteria based on the eligibility criteria and the property tax data;
store an identifier of the particular owner and the particular property in the first memory;
generate a notification command, wherein the notification command is effective to initiate the generation of a notification for the particular owner of the particular property;
receive a signal from the particular owner of the particular property, wherein the signal includes a notification election;
store the notification election in the first memory;
send the notification election to a tax lien processor, wherein the tax lien processor generates lien data related to a dated municipal tax lien on the particular property, the dated municipal tax lien is an amount equal to property tax on the particular property for a pending year and associated fees, and the dated municipal tax lien is structured with interest accruing at specified rates;
receive the tax lien data from the tax lien processor;
store the tax lien data in the first memory;
send the lien data to a tax anticipation security processor, wherein the tax anticipation security processor generates tax anticipation security (TAS) data related to a tax anticipation security based on the lien data, wherein the tax anticipation security is secured by the dated municipal tax lien in an amount equal to the property tax on the particular property for the pending year, the associated fees, and the interest accrued at the specified rates;
receive the tax anticipation security data;
store the tax anticipation security data in the first memory; and
generate the report, wherein the report includes data related to the owner, the property, the tax lien data, and the tax anticipation security data.

19. The device of claim 18, wherein the dated municipal tax lien data is related to a dated municipal tax lien that is junior to any earlier municipal tax liens on the particular property and senior to any subsequent liens on the particular property.

20. The device of claim 18, wherein the eligibility criteria includes a determination that the particular owner has adequate equity in the particular property.
